(19) United States
(12) Patent Application Publication
(10) Pub. No.: US 2022/0049842 A1
(43) Pub. Date: Feb. 17, 2022

(54) DEVICE WITH LIGHTING, LOCATION AND COMMUNICATION SYSTEMS

(71) Applicant: LIGHTUPTOYS.COM LLC, Sellersburg, IN (US)

(72) Inventors: Joshua C. Kelly, New Albany, IN (US); Christopher D. Kelly, New Albany, IN (US); Max Armendariz Lalama, Sellersburg, IN (US)

(21) Appl. No.: 17/503,931

(22) Filed: Oct. 18, 2021

Related U.S. Application Data
(63) Continuation-in-part of application No. 16/889,364, filed on Jun. 1, 2020, now Pat. No. 11,149,932.
Application No. 16/889,364 is a continuation-in-part of application No. 15/982,405, filed on May 17, 2018, now Pat. No. 10,674,588.
Application No. 15/982,405 is a continuation-in-part of application No. 14/750,896, filed on Jun. 25, 2015, now abandoned.
Application No. 14/750,896 is a continuation-in-part of application No. 17/335,447, filed on Jun. 1, 2021.

(51) Int. Cl. F21V 23/00; A44C 25/00; F21V 23/04; F21V 7/22

(52) U.S. Cl. CPC F21V 23/003; A44C 25/001; F21Y 2115/10; F21V 7/22; F21V 23/0435; F21V 23/0471

(57) ABSTRACT

An illuminating pendant that is affixed to a bubble producing toy, wherein the pendant includes a housing unit connected to one or more layers of translucent material, which layers are collinearly connected. An LED is secured to an edge of each layer and the housing unit includes control circuitry, which is electrically connected to the LEDs and a power source. The control circuitry includes a receiver and a proximity detection device, which detects a first signal location proximate to a first proximity beacon and illuminates the LEDs in a pattern associated with the first signal.

An illuminating lantern, which includes a base and a housing unit and multiple layers of collinearly connected translucent material secured between the base and housing. The housing unit includes control circuitry, which is electrically connected to LEDs and to a power source, and the control circuitry includes a receiver and a proximity detection device.

### CROSS REFERENCE TO RELATED APPLICATION

This application is a continuation-in-part of and claims priority to U.S. Ser. No. 17/335,447 filed on Jun. 1, 2021 and is a continuation-in-part of and claims priority to U.S. Ser. No. 16/889,364 filed Jun. 1, 2020, which application is a continuation-in-part of U.S. Ser. No. 15/982,405, filed May 17, 2018, now patented as U.S. Pat. No. 10,674,588, which application is a continuation-in-part that claims priority to U.S. Ser. No. 14/750,896 filed on Jun. 25, 2015. All publications, patents and patent applications referred to herein are incorporated by reference in their entirety.

### FIELD OF THE INVENTION

The present device relates to the field of entertainment devices, more particularly, to the field of entertainment devices that can be wearable or handheld and utilize electronics, lighting, location, and communication system(s).

### BACKGROUND

There is a need for devices that are capable of being worn or carried by a user, which utilize electronics, and lighting, location, and communication systems to activate certain electronic features of the device when coming into close proximity with a sender. There is also a need for devices that are worn by a user that act as the signal sender to other devices when they come into close proximity to displays that contain a receiver.

### SUMMARY OF INVENTION

There is disclosed an illuminating pendant that is affixed to a bubble producing toy. The illuminating pendant includes a housing unit, one or more layers of translucent material connected to the housing unit, wherein the one or more layers are collinearly connected. There are one or more LEDs connected to an edge of each of the one or more layers of translucent material and control circuitry is secured within the housing unit and is electrically connected to the one or more LEDs and to a power source. The control circuitry includes a receiver and a proximity detection device, which detects a first signal location proximate to a first proximity beacon and illuminates the one or more LEDs in a pattern associated with the first signal location.

There is also disclosed an illuminating lantern, which includes a housing unit and a base with at least three sides connected between the housing unit and base. Each side includes one or more layers of translucent material which are collinearly connected and includes images etched therein. One or more LEDs are connected to an edge of each of the one or more layers of translucent material and control circuitry is secured within the housing unit and is electrically connected to the LEDs and to a power source. The control circuitry includes a receiver and a proximity detection device, which detects a first signal location proximate to a first proximity beacon and illuminates the one or more LEDs in a pattern associated with the first signal location.

### BRIEF DESCRIPTION OF DRAWINGS

FIG. 1 is an embodiment of an illuminated pendant connected to an illuminated accessory with a first image displayed.

FIG. 2 is the illuminated pendant connected to an illuminated accessory of FIG. 1 with a second image displayed.

FIG. 3 is the illuminated pendant connected to an illuminated accessory of FIG. 1 transitioning between the first image and the second image.

FIG. 4 is a side view of another embodiment of a pendant.

FIG. 5 is a front perspective view of another embodiment of a pendant.

FIG. 6 is a rear perspective view of the pendant of FIG. 5.

FIG. 7 is a rear view of the pendant of FIG. 5.

FIG. 8 is a front view of the pendant of FIG. 5.

FIG. 9 is a perspective view of the housing unit of the pendant of FIG. 5.

FIG. 10 is a front view of another embodiment of an illuminated pendant connected to an illuminated accessory.

FIG. 11 is a top perspective view of another embodiment of an illuminating pendant with a housing unit surrounded by layers of translucent material.

FIG. 12 is a top perspective view of the housing unit of FIG. 11.

FIG. 13 is a top perspective view of the layers of translucent material of FIG. 11.

FIG. 14 is a partially open-faced view of the housing unit surrounded by the layers of translucent material of FIG. 11.

FIG. 15 is a top, perspective partial view of the housing unit of FIG. 11.

FIG. 16 is a top, perspective view of various inner contents of the housing unit of FIG. 11.

FIG. 17 is a top, perspective view of the illuminating pendant of FIG. 11 with conductive pins.

FIG. 18 is a top perspective view of the illuminating pendant of FIG. 11 with a magnet for securing the pendant.

FIG. 19 is a front view of a face of the pendant of FIG. 11 when illuminated.

FIG. 20 is an alternative face of the pendant of FIG. 11 when illuminated.

FIG. 21 is a front view of a transition face of the pendant of FIG. 1 between the image of FIG. 19 and the image of FIG. 20.

FIG. 22 is a side, perspective view of a second embodiment of an illuminating pendant affixed to a wearable band.

FIG. 23 is a side, perspective exploded view of the illuminating pendant affixed to the wearable band of FIG. 18.

FIG. 24 is a side view of the illuminating pendant affixed to the wearable band of FIG. 22.

FIG. 25 is a side view of the illuminating pendant affixed to the wearable band of FIG. 22.

FIG. 26 is a back view of the illuminating pendant affixed to the wearable band of FIG. 22.

FIG. 27 is a top view of the illuminating pendant affixed to the wearable band of FIG. 22.

FIG. 28 is a bottom view of the illuminating pendant affixed to the wearable band of FIG. 22.

FIG. 29 is a side, perspective view of another embodiment of an illuminating pendant with a wristband to which it can be affixed.

FIG. 30 is an exploded view of the illuminating pendant and wristband of FIG. 29.

FIG. 31 is a side, perspective view of the illuminating pendant and wristband of FIG. 29 affixed together.

FIG. 32 is a side, perspective view of the illuminating pendant and wristband of FIG. 29 affixed together with a lanyard attachment.

FIG. 33 is a side, perspective view of the illuminating pendant and wristband of FIG. 29 affixed together with three layers of translucent material removed.

FIG. 34 shows a side perspective view of the illuminating pendant of FIG. 29 with a handheld bubble producing toy to which it can be affixed.

FIG. 35 shows an exploded view of the illuming pendant, which can be affixed to a handheld bubble producing toy of FIG. 34.

FIG. 36 is a side, perspective view of the illuminating pendant and handheld bubble producing toy of FIG. 34 affixed together.

FIG. 37 is a side, perspective view of the illuminating pendant and handheld bubble producing toy of FIG. 34 affixed together with three layers of translucent material removed.

FIG. 38 is an exploded view of an illuminating lantern with a housing unit and sides which include multiple layers of translucent material.

### DETAILED DESCRIPTION OF DRAWINGS

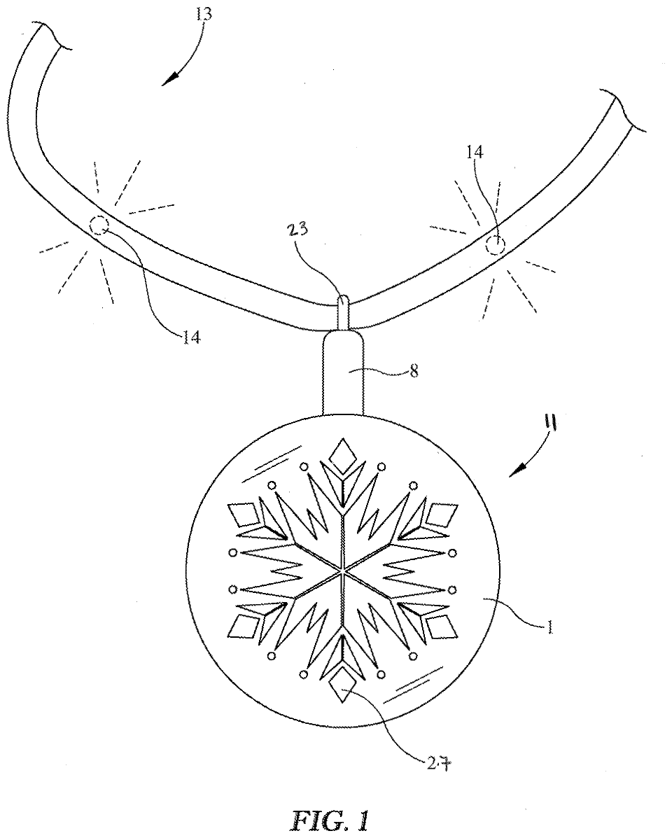

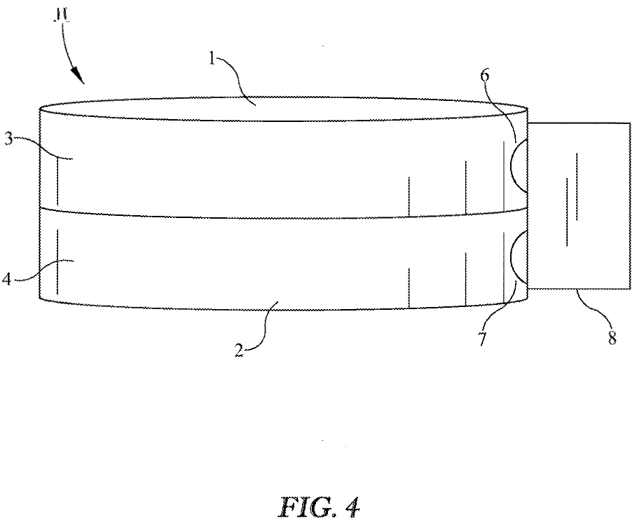

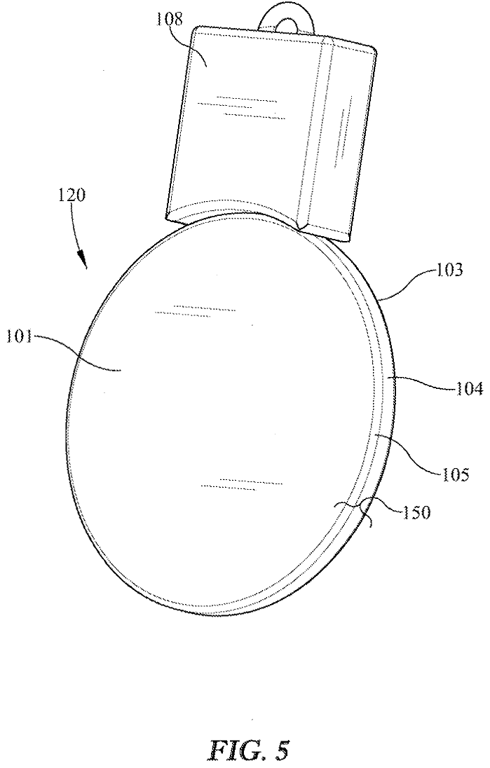

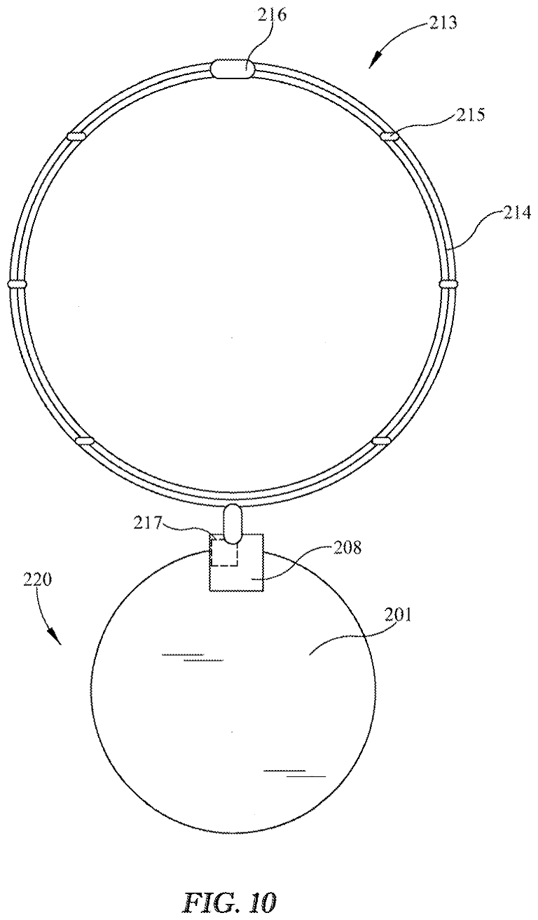

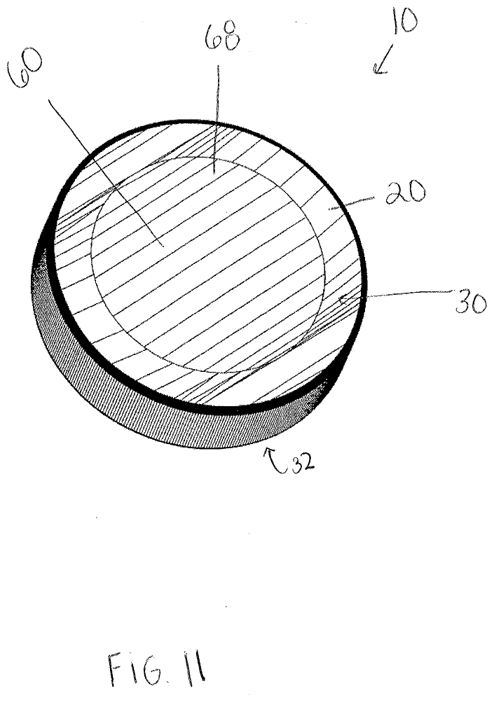

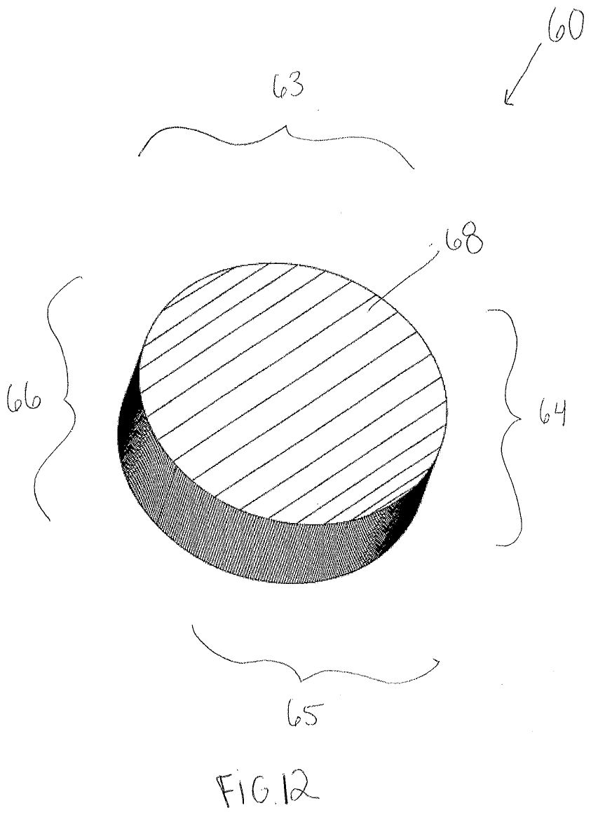

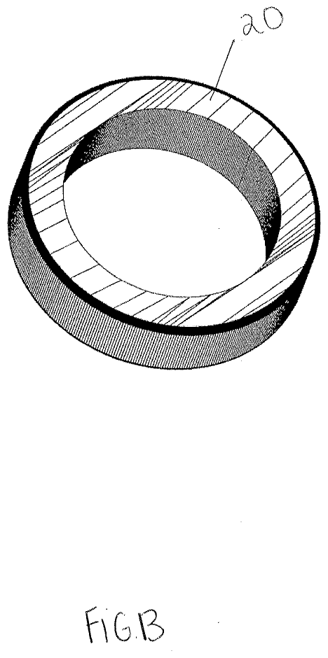

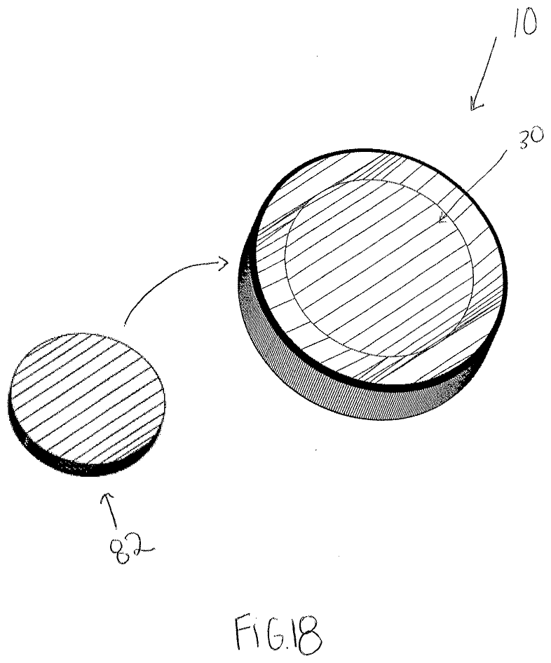

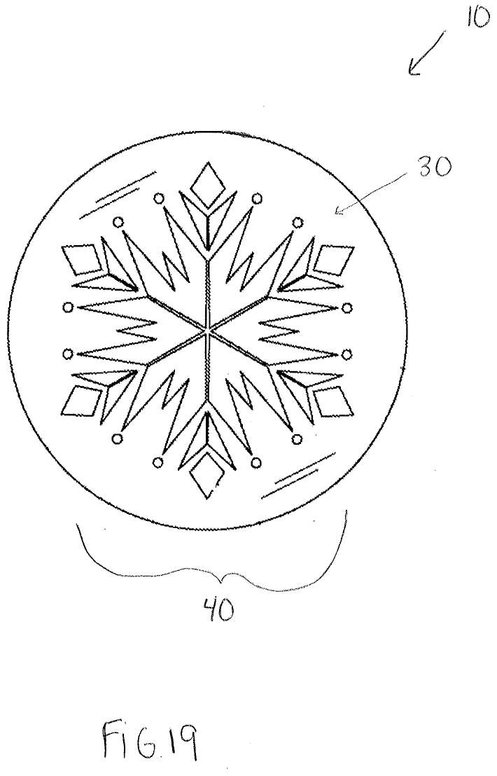

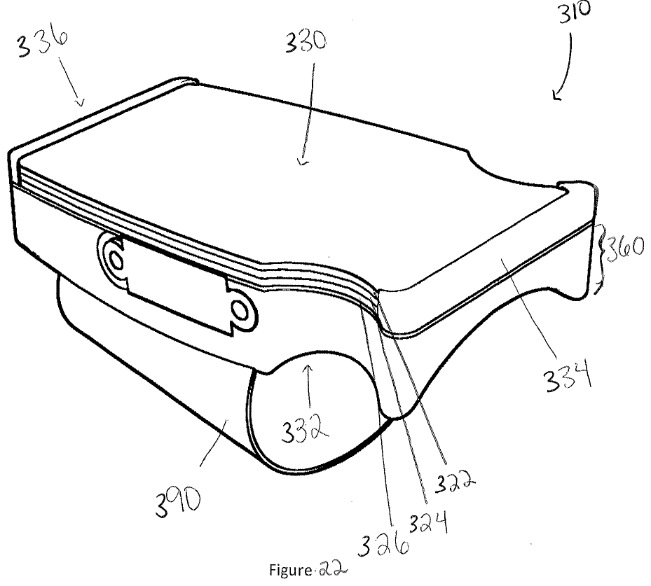

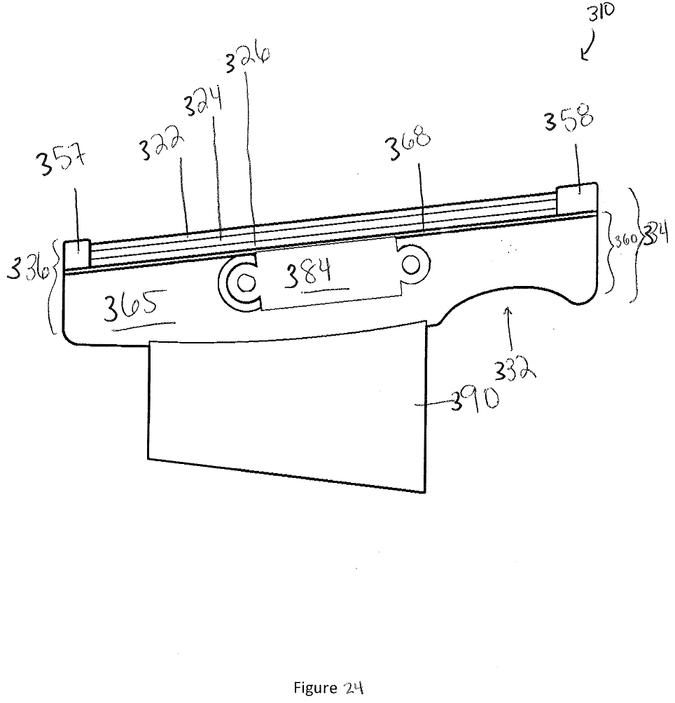

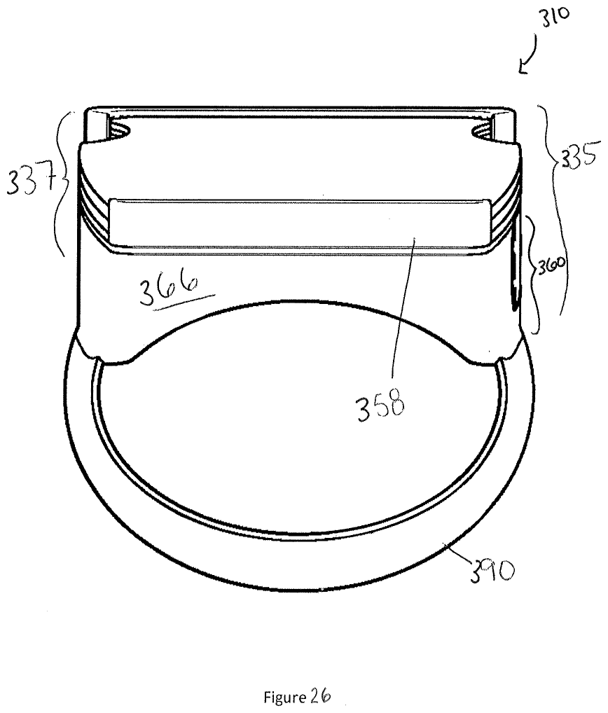

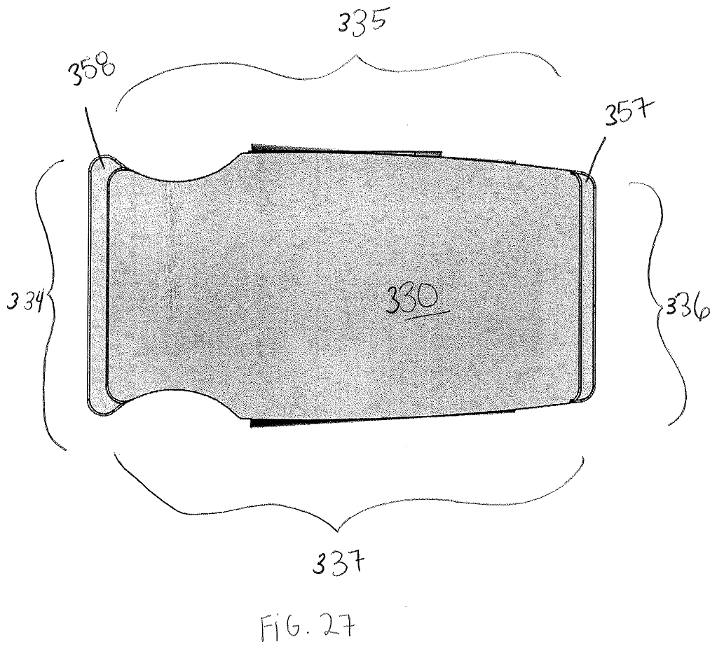

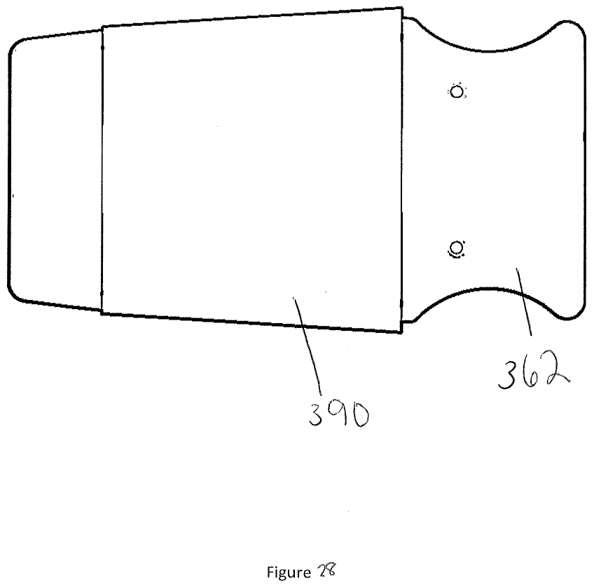

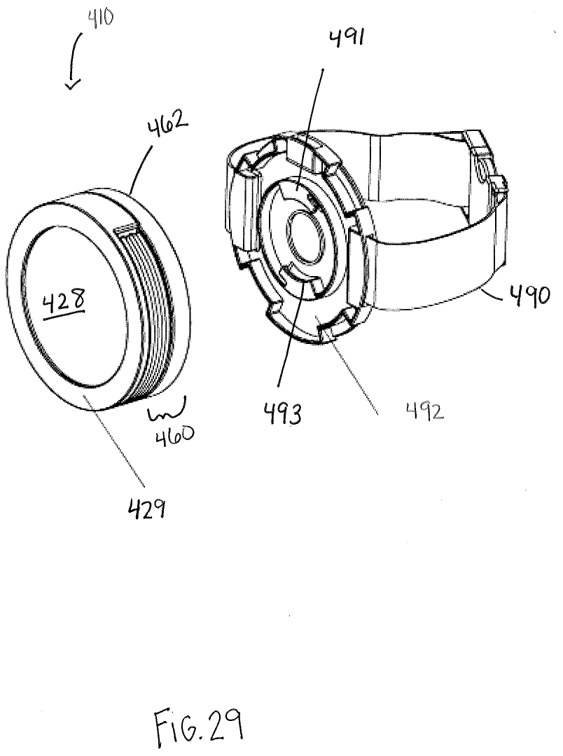

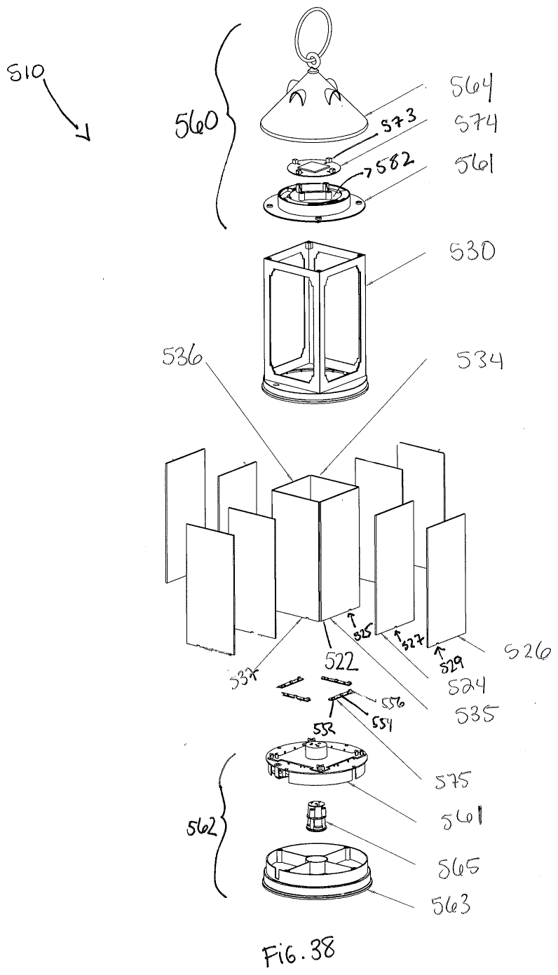

FIGS. 1-3 illustrate an embodiment of an illuminated pendant 11 connected to an illuminated accessory 13, where varying images on the pendant create an appearance of animation. FIG. 4 illustrates a side view of an embodiment of the pendant. FIGS. 5 through 9 illustrate various views of another embodiment of a pendant 120. FIG. 10 illustrates further features which may be used in addition to or in place of the various features and aspects described herein for all embodiments disclosed herein. FIGS. 11-18 illustrate an illuminating pendant 10 that includes a centrally located housing unit 60 surrounded by one or more layers of translucent material 20. FIG. 18 illustrates the illuminating pendant being capable of magnetically connecting to a user's clothing via a first magnet (not shown) and a second magnet 82. FIGS. 19-21 illustrate a front face 30 of the illuminating pendant 10, wherein the one or more layers of translucent material include images (40, 42) etched into the one or more layers of translucent material and the layers encompass the entire front face of the illuminating pendant, similar to FIGS. 1-3. FIGS. 22-28 illustrate the illuminated pendant 310 affixed to a wearable band 390. In this implementation, the housing unit is covered entirely by the one or more layers of translucent material, so the one or more layers of translucent material encompass the entire front face of the pendant. Although the pendant is shown in a circular shape in FIGS. 1-21, the pendant can be any shape, as illustrated in FIGS. 22-28 or size depending on desired specifications. FIGS. 29-298 show another embodiment of an illuminating pendant 410, which can be affixed to a wristband or to a bubble producing toy. FIG. 38 shows an illuminating lantern. Although the way in which the pendant is worn by a user varies, and the configuration of the one or more layers of translucent material in relation to the housing unit varies, the general structural components of the illuminated pendant and lantern are consistent throughout the embodiments described herein and should be interpreted as applying to each embodiment. Moreover, the various inner components of the housing unit, such as the control circuitry of each embodiment may vary, but the inner components of the housing unit disclosed herein should be interpreted as applying to each embodiment.

The embodiment shown in FIGS. 1-3, includes an illuminated pendant 11 with a front face 1, which displays one or more illuminated images (discussed in further detail herein), and a housing unit 8, which may contain various electrical components necessary for the operation of the illuminated pendant. In some embodiments, the housing unit may further include a connecting loop 23 that allows the illuminated pendant to be connected to an illuminated accessory 13. In other embodiments, the pendant and the illuminated accessory may be connected by other means, including but not limited to, being integrally molded together, welded together, snapped or buttoned together, connected via magnets, or the like. In still other embodiments, the pendant may not be connected to an illuminated accessory at all and may stand-alone.

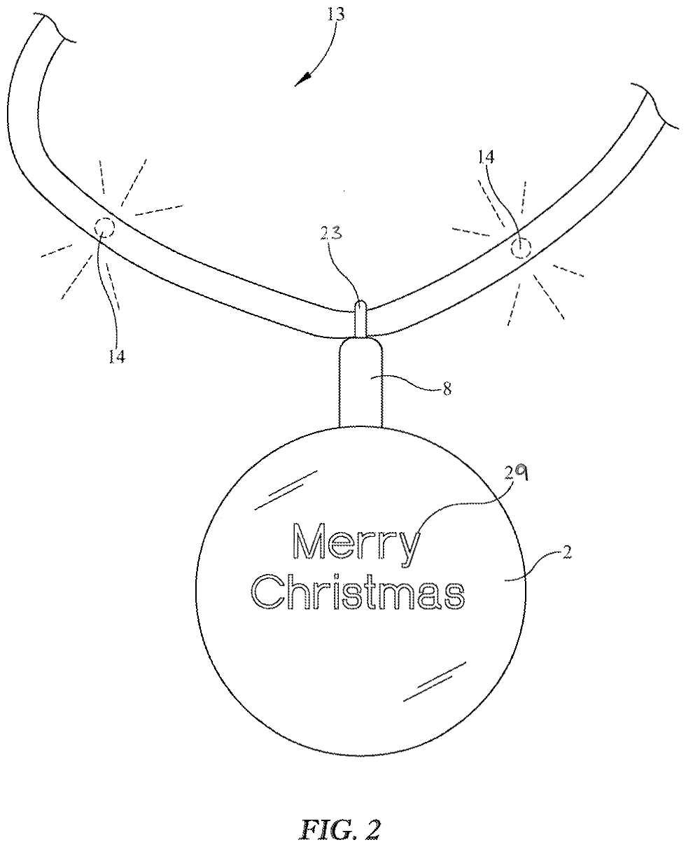

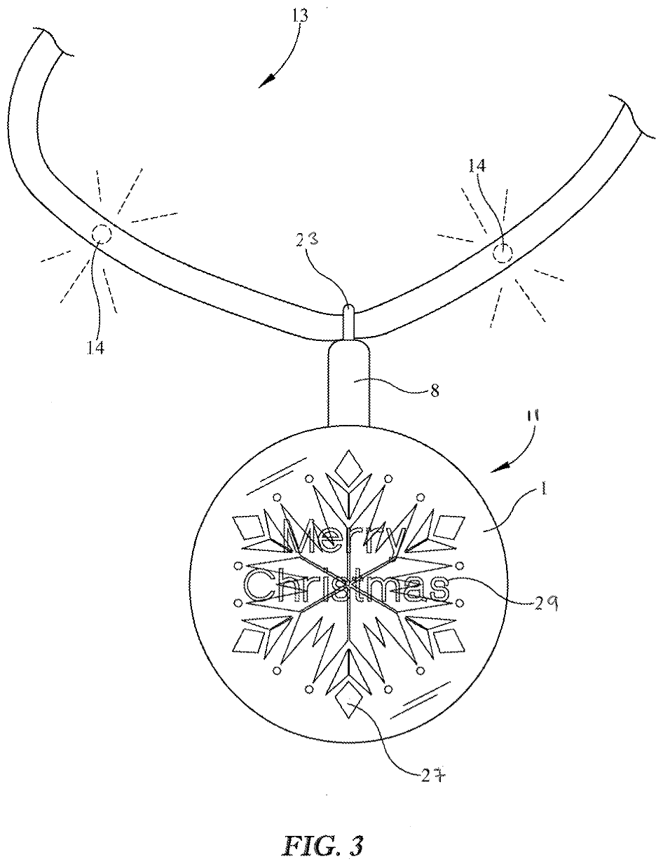

Referring now specifically to FIG. 1, the pendant 11 includes a first image 27, a snowflake, illuminated and visible on the front face 1. In contrast, in FIG. 2 the pendant includes a second image 29, the text “Merry Christmas”, which is also illuminated and visible on the front face. FIG. 3 illustrates the transition period between the first imagine and the second image where both images may be visible. As will be described in greater detail herein, a plurality of light emitting diodes (LEDs) and layers of translucent material are used to create an appearance of animation between the first image and the second image. In some embodiments, the transition period between the first image and the second image illustrated in FIG. 3 may be quite brief, for example a fraction of a second, in order to provide an appearance of animated movement between the two or more illustrated images.

Where present, the illuminated accessory 13 may operate independently from or in conjunction with the pendant 11. In some embodiments, the illuminated accessory may include a light string system, with one or more LEDs 14. In other instances, the illuminated accessory may include an electroluminescence assembly, with an electroluminescent wire, sheet, panel, or tape, and/or an inverter. The illuminated accessory may have a power source independent from the power source of the pendant (not visible in FIGS. 1-3, see FIG. 10) or, in some instances may share a power source with the pendant. This power source may be a battery or other device connected to a printed circuit board. The illuminated accessory may be constructed of a pliable material, including but not limited to plastic, thermoplastic, cloth, fabric, wire, rubber, metal, elastic polymer, or other similar material that can support the pendant and which can be utilized to extend around the neck of a wearer while supporting the pendant. The illuminated accessory may also be constructed of any translucent, transparent or other material and may be constructed so as to be flexible or inflexible. In some embodiments, the light string system may be constructed within the illuminated accessory and may include an illumination or lamp system electrically connected together with conductive wire or other electrically connective material; each illumination device, lighting or lamp system may further, in some embodiments, include a light assembly and a socket assembly. In various implementations, the light string system and/or the electroluminescence assembly may be connected to the LEDs, power source, and associated circuitry used to control the illuminated accessory. The associated circuitry of the illuminated accessory controlling the LEDs and/or electroluminescence assembly may also be used to control the light patterns produced by the various illumination devices or lighting units of both the accessory and the pendant. In some embodiments, the light pattern on the illuminated accessory may be random, regular, a controlled sequence or pattern, a custom sequence or pattern, and/or sequence or pattern that incorporates constant timing, variable timing, and/or dimming function. In some instances, the pattern or light sequence of LEDs may be utilized in addition or in place of the electroluminescence assembly and either may be utilized to provide illumination which is coordinated with the pattern or light sequences of the pendant.

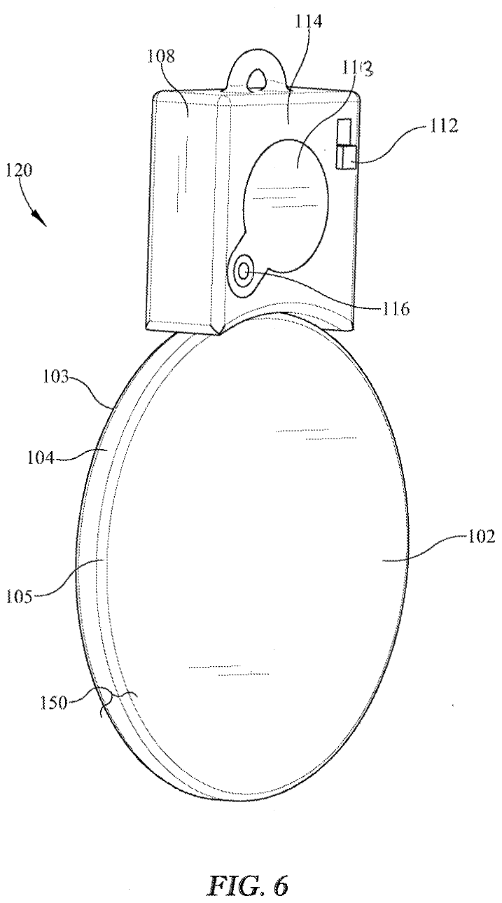

FIG. 4 illustrates a side view of an embodiment of the pendant 11. In the embodiment illustrated in FIG. 4, the pendant may be formed of a first layer 3 and a second layer 4 and may include a front face 1 and a rear face 2. However, this is not intended to be limiting, as in some embodiments the pendant may be formed of three or more layers, as exemplified in FIGS. 5-6. Each layer may be constructed of a translucent or transparent material capable of transmitting and/or radiating light. For example, in some embodiments, the translucent material may include but not be limited to, glass, plexiglass, acrylic, resin, and/or a combination thereof. Each layer of the pendant may have a light reflective image 27, 29 contained in and/or on the translucent material. In some embodiments, the image may be etched, sandblasted, molded, engraved, imprinted, ingrained, cut, impressed and/or outlined into or on the translucent material forming a light radiating portion. Further, such images may be produced by embedding other reflective, refractive or other material within the layer. For example, the layers may be molded with specific placement of a refractive material contained therein. Also, for example, the material may be molded first and then laser etched. Alternatively, each layer may be produced separately, images positioned or formed thereon and then combined later. Although generally referred to herein as “images” this is not to be understood as limiting, as the image may be text (e.g. “Merry Christmas”), logos, slogans, characters, and/or other visual content. Since both the first layer and the second layer are constructed of a translucent or transparent material, in some examples, the images contained within, or on, each image may be visible from both the front face and the rear face when illuminated.

The first layer of translucent material 3 may be connected to or positioned adjacent of a first LED 6, which may be designed to be used in connection with illumination of the first layer of material. Similarly, the second layer of material 4 may be connected to or positioned adjacent of to second LED 7, which may be designed to be used in connection with the second layer of translucent material. These LEDs may direct light into or through the layers of transparent materials. By using each LED either alone or in combination with their respective layers, an appearance of animation may be created by switching between the LEDs as is described in detail herein. In some embodiments, the LEDs may be housed within the housing unit 8, and then coupled with the layers of the pendant 11.

By coupled, it is meant that the LEDs may be in illuminating engagement with the layers 3, 4 and not necessarily be mechanically connected. For example, the LEDs may be positioned directly adjacent to an edge of the layers. In other examples, the LEDs may be positioned directly adjacent to the layers and utilized directional optics to focus emitted light from the LEDs into the layers. Also for example, the LEDs may be embedded within the layers and/or in combination therewith utilize reflective optics, reflectors, directional lenses and the like to implement illumination of the respective layer.

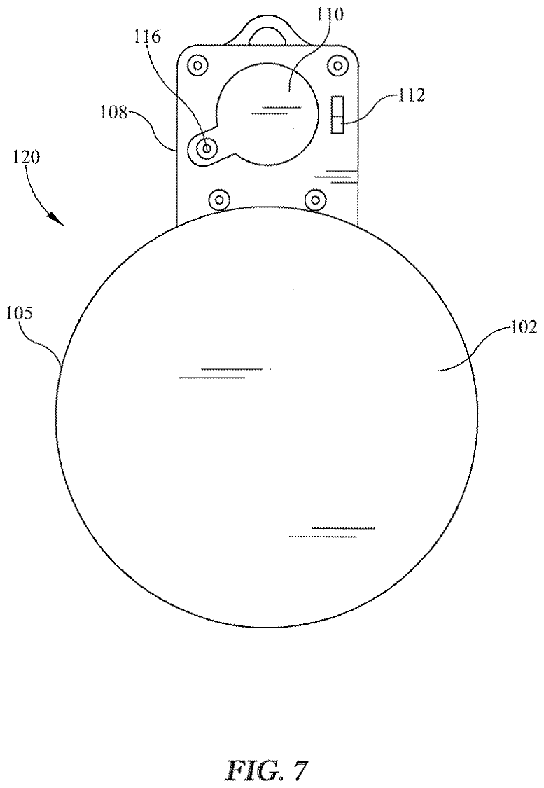

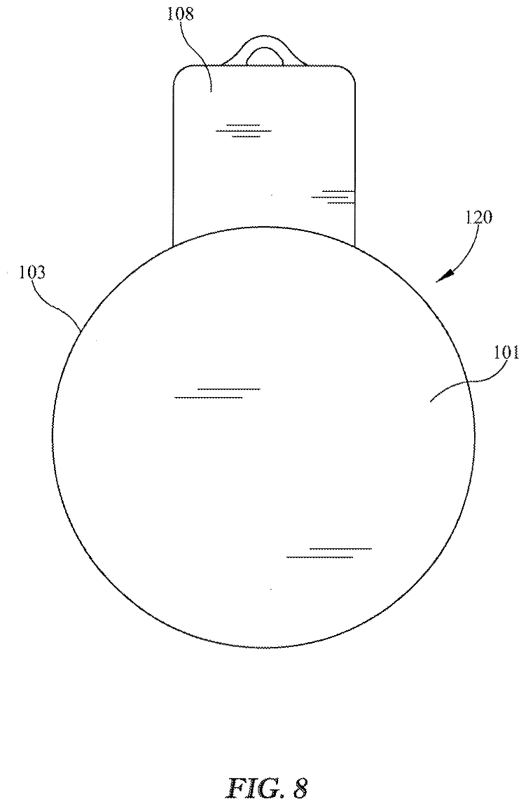

In some implementations, the LEDs 6, 7 may be integrated into the layers of translucent material 3, 4 by cutting a hole into each layer or by forming an opening during molding, in which each LEDs may be placed. The sides may then be covered with a non-translucent material so that the majority of light emitted from the LEDs is transmitted through the corresponding layer of translucent material. The housing unit 8 may further include circuitry associated with and/or used to control the LEDs and a power source. This circuitry may be used to control the light patterns of the LEDs and may include a printed circuit board having an embedded LED controller which may control various characteristics of the LEDs in the pendant and/or in combination with the accessory. In implementations, the control circuitry may include functional control of the LED intensity, color temperature, color, illumination duration and timing. Such control may further include control modulation such as, for example, frequency or amplitude modulation. In some embodiments, the control of the light patterns may be random or regular, or they may be a controlled and continuous sequence or pattern, a custom sequence or pattern, and/or sequence or pattern that incorporates constant timing, variable timing, and/or dimming. The housing unit may also include a switch or other circuit activating or deactivating the device (see FIGS. 7 and 8). The switch or other circuit for activating or deactivating the device may be mechanical, such as a toggle switch, depression switch, three-position switch and other similar mechanical activation assemblies. The switch or other circuit may also incorporate activation through embedded instructions and or receipt of activation signals received by the housing unit and included electronics and circuitry. For example, the housing unit may include a receiver for receiving signals which may activate the illumination features of the device. The switch or other circuit may further incorporate proximity detection devices, such as for example RFID or other types of electronics which senses location, proximity or other wireless instructions which would indicate or instruct illumination. Such device may include instructions and circuitry operable to detect location in respect to a transmitted beacon. For example, the device may automatically activate upon nearing a display, feature, attraction or other location within an amusement park which is transmitting a unique beacon which, when received by the device, causes the device to illuminate in a predetermined manner. Other automated instructions may further be implemented such as emitting colors, playing predefined audio stored in memory of the device or received by the receiver of the device, playing signals which are streamed and received by the integrated receiver, and similar functionality. For example, the device may include a proximity detection which includes a blu-tooth beacon receiver. Upon receipt of a unique beacon signal, the device may be programmed by instructions stored in memory to activate in a particular manner and/or play specific prerecorded or streamed audio signals. Alternatively, the device may incorporate RFID detectors wherein the device, upon recognition of a specific RFID signal, begins emitting a predetermined sequence of signals. Other implementations may be implemented such as GPS location detection and determination.

In some embodiments, the pendant 11 may further include one or more electroluminescent wires, sheets, panels, which may be used in addition to, or in place of, the LEDs 6, 7. Similar to the LEDs, the one or more electroluminescent wires, sheets, panels, or tape may, in some instances, only be used in connection with one layer of translucent material and may not be shared or used by any other layer of translucent material.

FIGS. 5 through 9 illustrate various views of another embodiment of a pendant 120. The embodiment illustrated in FIGS. 5 through 9 includes three layers of material 103, 104, 105, which collectively form a combined piece of material, wherein the layers are collinearly connected together. The material may be transparent, translucent, reflective or refractive or any combination thereof. Similar to the embodiment described with reference to FIG. 4, the pendant 120 may have a front face 101 and a rear face 102. Also, similar to the embodiment described with reference to FIG. 4, each layer of material may be coupled to or connected with an LED located within the housing unit 108. In implementations, there is a separate LED corresponding to each layer, and each LED is designated to be used in conjunction with the adjacent layer of material to which it corresponds.

Alternatively, or in addition thereto, the layers of material may be translucent, transparent, reflective or refractive or combinations thereof. For example, depending on the desired illumination characteristics, combinations of material may be utilized side by side. For example, a first layer of material have a known refractive index may be positioned adjacent to a second different layer of material having a refractive index different than the first layer. Similarly, additional layers of material may be used with similar or different material characteristics as the first or the second layer or have unique illumination characteristics itself. In such a manner, light entering into the respective layer may be controlled and prevented, promoted or partially allowed to transmit into an adjacent layer.

Each layer of translucent material 103, 104, 105 may contain a separate and distinct image etched, engraved, imprinted, cut, impressed, or otherwise present on or in the material forming a light radiating portion. In some embodiments, this image may contain one or more colors. The appearance of animation may be created when a first LED illuminates a first image in a first layer of material, which may then blend into a second image illuminated by a second LED by fading or dimming out the first image while simultaneously fading or dimming in the second image, for example by having each image illuminated at some proportion of the maximum brightness of the respective LED. Alternatively, one image may be completely switched off (e.g. no LED illuminated) and another image completely switched on (e.g. LED illuminated) with no overlap in time. Further, as the LEDs are controlled by circuitry or other PCB located within housing 108, fine illumination control of the multiple layers may be achieved including switching quickly between illumination of the images to provide full animation appearance. Although the creation of an appearance of animation is discussed in terms of a first image and second image this is not intended to be limiting, as there may three, four, five or more images formed on separate or combined layers. For example, in some implementations, the respective layer may include a plurality of images, each of which react to or are illuminated by specific illumination characteristics of the LED. For example, a first material in the first layer may be formed of a material that refracts, reflects or illuminates in light of a first predefined frequency. Further, a second material in the first layer may be formed of a second material that reflects, refracts or illuminates in light of a second predefined frequency. By controlling the output characteristics of the LED in the first layer, the same layer may illuminate two different images. Control of such illumination control characteristics may include control and modification of output frequency, color, modulation, and or intensity, to name a few aspects. Other known control characteristics may be modified in such implementation as well. In some examples, the lighting sequence produced by the LEDs may be a chaser pattern, a blinking pattern, a fixed illumination of a constant brightness, and/or a variable illumination pattern.

Similar to the embodiment discussed with reference to FIG. 4, in some implementations all three layers 103, 104, 105 are constructed a translucent material the image(s) contained within, or on, each layer may be visible from both the front face 101 and the rear face 102, when illuminated by the respective light source.

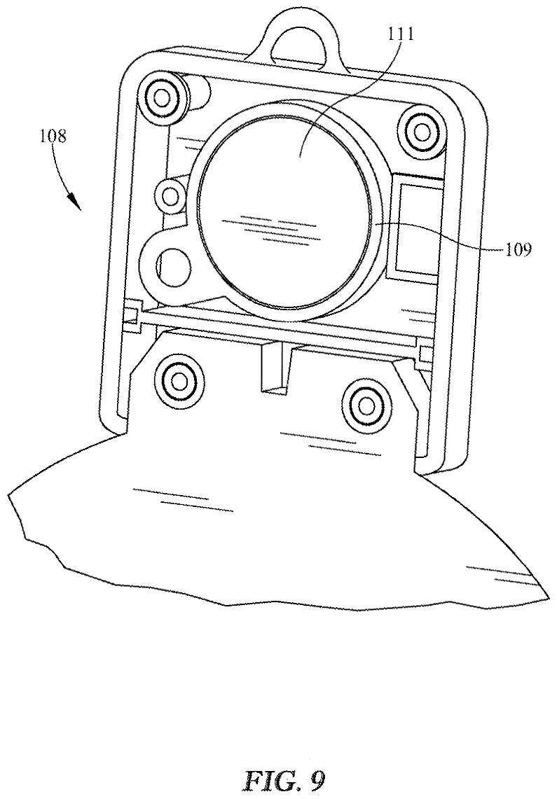

Referring now specifically to the exemplified embodiment of FIGS. 6 and 7, a rear surface 114 of the housing unit 108 is illustrated. In implementations, located on the rear surface of the housing unit may be a battery compartment door 113 and a control switch 112. Other power sources and activation switches may be utilized. In some embodiments, the battery compartment door may be secured through a recessed screw 116. However, this is not intended to be limiting as in other embodiment the battery compartment door may be secured through a snapping mechanism and/or a tension mechanism. When the battery compartment door is opened as is illustrated in FIG. 9, a battery 111 may be exposed for replacement or servicing. In some embodiments, the control switch may be a simple on/off switch; however, in other embodiments the control switch may be a three, four, or more position switch that may allow a user to customize the order, timing, etc. of the sequence of lights. In addition, or in place thereof, the switch may be replaced with a software or signal controlled switch that is controlled by the internal controller and circuitry of the housing unit and which may be communicatively activated by a remote device. The switch or other circuit may also incorporate activation through embedded instructions and or receipt of activation signals received by the housing unit and included electronics and circuitry. For example, the housing unit may include a receiver for receiving signals which may activate the illumination features of the device. The switch or other circuit may further incorporate proximity detection devices, such as for example RFID or other types of electronics which senses location, proximity or other wireless instructions which would indicate or instruct illumination.

FIG. 10 illustrates further features which may be used in addition to or in place of the various features and aspects described herein. For example, the embodiment of an illuminated pendant 220 is shown where the pendant may include a tracking or communication system. The tracking or communication system may include at least one of: a tracking apparatus 217; a communication transmitter/receiver device; at least one of a control device; a power source; a controlling, executing, or operating software application that may be utilized to control or operate a control device or communication transmitter/receiver device; an LED light; a switch or a sensor; circuitry to control an LED light; or a translucent material permitting the transmission of light. The tracking apparatus, control device or communication transmitter/receiver device may, if present, receive or transmit various electronic signals, such as GPS, Wi-Fi, radio wave, Bluetooth, RFID, proximity detections signals, audio, vibration, light, sound, or infrared. In various implementations, a communication transmitter/receiver device may be utilized and be in electrical communication with or incorporate therein a tracking apparatus and or associated electronics. The communication receiver or communication transmitter may be located within, or attached to, a controller within the housing 208 or in other positions embedded within the device. Additionally, a control device may be utilized and remote from the device 220, the control device being, in some implementations, a remote control, computer, tablet, smart phone, other smart device, sound device, public address (PA) system, audio system, amplifier system, or one or more speakers. Where present, the remote control device, which may be defined as an electronic device used to wirelessly control another electronic device, may include a button or other signal that when initiated may send a signal to the communication transmitter or receiver device located in the tracking apparatus or other control electronics of the device. The controlling, executing, or operating software application may, when instructed to, send a signal from the communication transmitter/receiver (located in the control device) to the device tracking apparatus.

As illustrated in FIG. 10, the tracking apparatus 217 may incorporate multiple features noted herein including communication, proximity detection, control and location functions. The tracking apparatus may be within the housing unit 208 of the device along with lighting, location, and communication systems. Alternatively the tracking system may be removably attached via an attaching mechanism (e.g. adhesive, hook and loop, snaps, or the like) to the housing unit 208. The tracking apparatus may be connected to the power source or the circuit activating/deactivating device (e.g. the on/off switch—not illustrated) used to control the LEDs or the electroluminescence assembly, as described herein. The tracking apparatus may be used to facilitate control of the lighting patterns produced by the LEDs. For example, the apparatus may receive instructions for a localized and specialized illumination sequence when instructed or when proximity to a particular location is detected. Alternatively, complete illumination instructions may be transmitted by a remote controlling device and received by the device 220 based upon the devices location, time of day, or other requirements or characteristics.

In some embodiments, the tracking apparatus 217 or control device housing may also include a speaker, other audio device, or a vibrating device. The control device may send a signal from the communication transmitter/receiver device located in the control device to the communication transmitter/receiver device located in the tracking apparatus, resulting in the emission of a sound, vibration, or light from the LEDs or electroluminescence assembly. The switch or sensor may be capable of being connected to other electronics, and in some instances, may be at activated by motion, acceleration, or impact, which may cause the LEDs and control circuitry to remain active for a minimum period of time. Where there is no motion, acceleration, or impact sensed for a minimum period of time, the LEDs and associated control circuitry may enter a low-energy mode to conserve battery; however, sensed motion, acceleration, remote signals or impact may initiate a wake up of the LEDs and associated control circuitry from the low-energy mode. In other embodiments, a sensor may sense acoustic energy or noise from the environment and convert that acoustic energy or noise into a signal, which may then trigger control of the lighting, or lighting sequence, of the LEDs.

The tracking apparatus may, in addition or in place thereof, include various control electronics such as PCB, microcontroller, microprocessor, memory and associated electronics such as transmitters, receivers, GPS, blue tooth communication systems, separate controllers, WiFi communication subsystems and the like. The associated memory may further include stored instructions to control and operate the various features hereof, including stored audio files, video files, pre-recorded materials and illumination cycles and shows as well as other necessary instructions to implement the features outlined herein. As well, such control electronics may be alternatively located within the housing and separate from the features of the tracking apparatus. In some embodiments, a single PCB may combine all features and structures/electronics/circuits. In other implementations, such features may be separately implemented.

Returning to FIG. 10, the pendant 220 may be attached or otherwise connected to an illuminated accessory 213. The illuminated accessory may include a light string system 215 with one or more LEDs 214, as well as an illuminated accessory power source 216 to power the illuminated accessory. In some instances, as described previously herein, the illuminated accessory may include an electroluminescence assembly in place of, or as a supplement to, the light string system shown.

Various other embodiments of an illuminating pendant 10, 310 are shown in FIGS. 11, 19-26. The embodiments of the pendant shown in FIGS. 11, 12, 17, 22, 24-26 includes a housing unit 60, 360 that comprises control circuitry that is electrically connected to a power source and one or more LEDs. The one or more LEDs are associated with one or more layers of translucent material 20, 322, 324, 326, which layers are connected to the housing unit. Through illumination of the one or more LEDs associated with the one or more layers of translucent material, the illuminated pendant displays illuminated images and animation, particularly when the layers include light reflective images etched therein.

The pendant 10, 310 is made of any material but is preferably made of plastic that is durable and can withstand being dropped. As shown in FIGS. 11, 17-21, and 22-23, and 27, the pendant includes a front face 30, 330 a rear face 32, 332, and as the embodiment of the pendant in FIGS. 22-28 is not circular, sides 334, 335 336, 337. As shown in the embodiment in FIGS. 11 and 17-18, the front face of the illuminating pendant includes a centrally located housing unit 60 surrounded by one or more layers of translucent material 20. As shown in FIGS. 19-27, the front face of the pendant is encompassed by one or more layers of translucent material. The one or more layers can be connected to any portion of the housing unit and in any configuration and each layer is constructed of a translucent or transparent material capable of transmitting and/or radiating light. For example, in some embodiments, the translucent material includes, but is not limited to, glass, plexiglass, acrylic, resin, and/or a combination thereof. The pendant can illuminate though the front face, the back face and/or through the sides of the pendant. Moreover, certain portions of the pendant may be constructed of an opaquer material to direct the light from the one or more LEDs to shine through more prominently from select areas of the pendant. There can be multiple one or more layers of translucent material configured throughout the pendant. Moreover, the front face and/or layers of translucent material may be interchangeable.

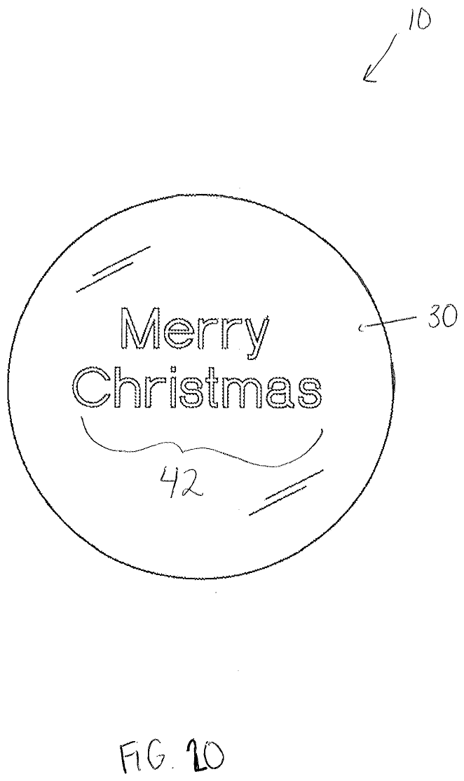

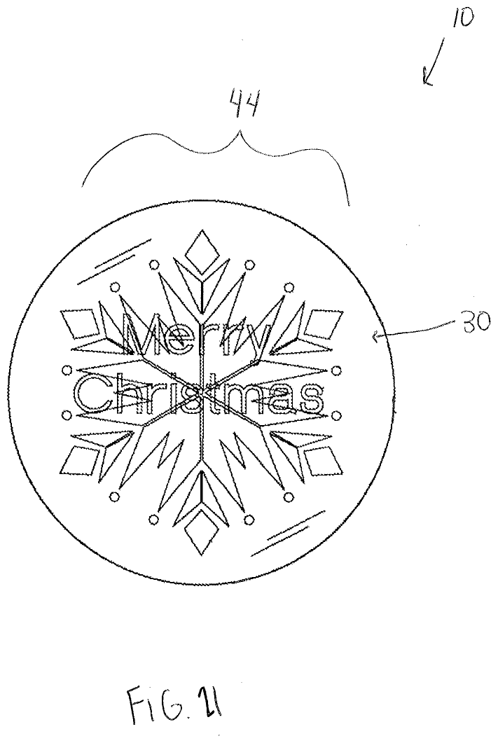

As shown in FIGS. 19-21, the layers of the translucent material 20 include light reflective images 40, 42 contained in and/or on the translucent material. These images are achieved through the various techniques discussed herein, for example as discussed for FIGS. 1-3. As shown, the pendant 10 includes three layers of translucent material that are connected collinearly to form a combined piece of translucent material. A first image is etched into the first layer, a second image is etched into the second layer and a third image is etched into the third layer etc. The one or more LEDs associated with the layers of translucent material create an appearance of animation between images located on each layer. As displayed in FIG. 19, the pendant includes a first image 40, a snowflake, illuminated and visible on the front face 30 of the pendant. In contrast, in FIG. 20, the pendant includes a second image 42, the text “Merry Christmas”, which is also illuminated and visible on the front face of the pendant. FIG. 21 illustrates the transition period 44 between the first image and the second image where both images may be visible of the front face of the pendant.

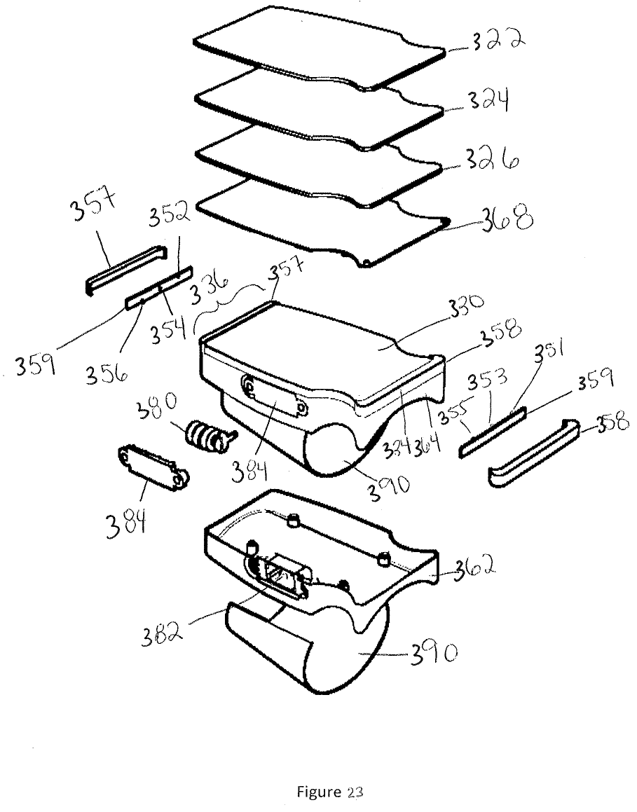

The one or more LEDs are associated with the one or more layers 20 in different configurations depending on the location of the one or more layers in relation to the housing unit 60. For example, as shown for the illuminating pendant 310 shown in FIGS. 22-28, the one or more layers cover the housing unit in a configuration covering the entire front face 330 of the pendant. As shown in FIG. 23, each horizontal side 334, 336 of the pendant includes three LEDs 352, 354, 356 and 351, 353, 355. These LEDs are secured for instance via covers 357, 358 that screw into the horizontal ends of the layers of translucent material. These covers also combine the three layers of translucent material into one colinear piece of translucent material and secure the layers to the housing unit. As shown in FIG. 23, the LEDs are secured to bars 359 at varying heights to correspond with the respective translucent layer. The LEDs can be different colors and size. Accordingly, the first layer 322 of translucent material is connected to or positioned adjacent of a first LEDs 351, 352, which are designed to be used in connection with illumination of the first layer of material. Similarly, the second layer of material 324 is connected to or positioned adjacent to second LEDs 353, 354 which are designed to be used in connection with the second layer of translucent material. Similarly, the third layer of material 326 is connected to or positioned adjacent to third LEDs 355, 356 which are designed to be used in connection with the third layer of translucent material. These LEDs direct light into or through the layers of translucent materials. By using each LED either alone or in combination with their respective layers, illumination affects are created by switching between the LEDs. Moreover, the LEDs associated with each layer can be integrated into the layers of translucent material by cutting a hole into each layer or by forming an opening during molding, in which each LEDs are placed. The sides are then covered with a non-translucent material, i.e., the bars, so that most of the light emitted from the LEDs is transmitted through the corresponding layer of translucent material.

To ensure illumination of each layer shines through the front face 330 of the pendant, the first layer of material 322 has a known refractive index positioned adjacent to a second different layer 324 of material having a refractive index different than the first layer.

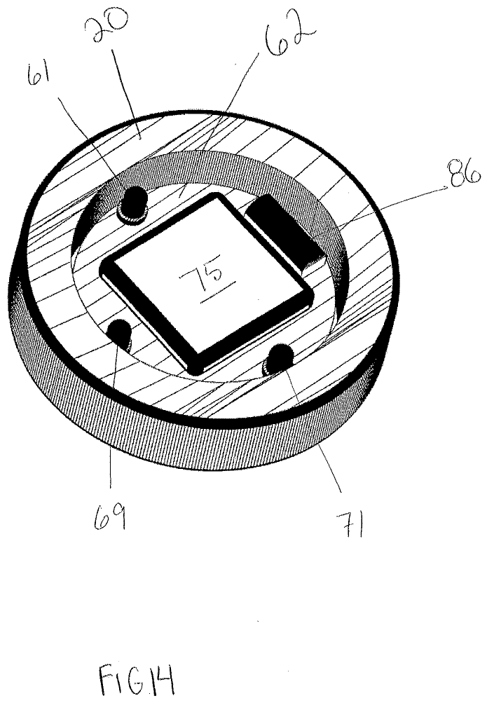

As shown in the embodiment of the pendant in FIG. 14, the one or more LEDs 61, 69, 71 are housed within the housing unit 60 and then coupled with the layers 20 of the pendant 10, such as discussed for the embodiment shown in FIG. 4.

In some embodiments, the LEDs are visible through the layers of translucent material. In some embodiments, for example and not shown, the first layer includes an image etched in a top portion of the ring of translucent material surrounding the housing unit and an LED 61 is associated with this first layer to illuminate the first image. A second layer includes an image etched in a middle portion of both sides of the ring and an LED 69 is associated with this second layer to illuminate the second image. A third layer includes an image etched in a bottom portion of the ring and an LED 71 is associated with this third layer to illuminate the third image. For instance, the first, second and third LED may be arranged at heights that correspond to the thickness and layer of translucent material for which they will be illuminating. When the LEDs associated with each layer illuminate, the images create a moving animation from a top portion of the pendant, to a middle portion, to a bottom portion. The images can be etched into any portion of the layers of translucent material.

As shown in FIGS. 14-17, the housing unit 60 contains control circuitry that controls and activates electrical components of the pendant 10. Although not shown for the embodiment 310 shown in FIGS. 22-28, the housing unit 360 of said pendant also includes control circuitry. The one or more LEDs 351, 352, 353, 354, 355, 356, 61, 69, 71 of the embodiments of the pendant shown in FIGS. 11-28 are controlled by circuitry such as a printed circuit board 74, or microprocessor 75 located within housing unit.

As shown in FIGS. 11, 12, 14, and 22-28 the housing unit of each embodiment of the illuminating pendant 10, 310 includes a housing unit 60, 360. The housing unit includes a base 62, 362 with sides 63, 64, 65, 66, 363, 364, 365, 366 and a cover 68, 367 that secures or seals to the sides of the base. In the embodiment of the pendant shown in FIGS. 11 and 14, the housing unit is secured centrally inside the layers of translucent material 20. FIGS. 22-28 show the housing unit secured underneath the layers of translucent material. The housing unit can be secured or connected to the layers of translucent material in any configuration.

As shown in FIGS. 14-17, the housing unit 60 contains various control circuitry that controls and activates electrical components of the pendant 10. Although not shown, the control circuitry is utilized with the illuminating pendant affixed to the wearable band 390 and the magnet 382. This circuitry is used to control the light patterns of the LEDs for example, with a printed circuit board 74 that has an embedded LED controller which controls various characteristics of the LEDs in the pendant and/or in combination with the wearable band of FIGS. 22-28, for example as discussed in the embodiment of FIG. 10.

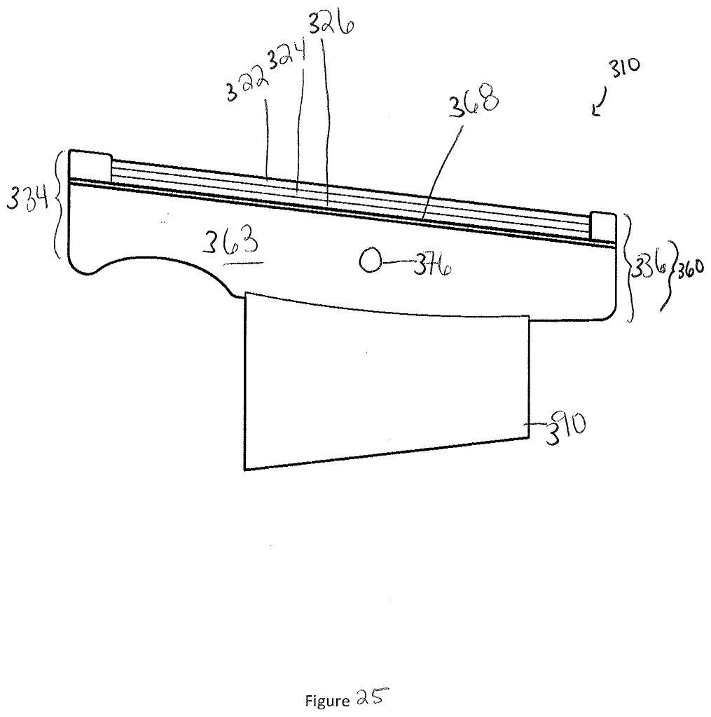

As shown in FIG. 25, the housing unit 360 also preferably includes a switch 376 connected to the power source or other circuit activating or deactivating the device, for example as discussed in the embodiment of FIG. 10. For example, as shown in FIGS. 14-16 the housing unit includes a receiver 77 for receiving signals which may activate the illumination features of the device. The switch or other circuit may further incorporate proximity detection devices 83, such as for example RFID or other types of electronics which senses location, proximity or other wireless instructions which would indicate or instruct illumination. See discussion for FIGS. 6-10 for other circuitry that can be included in the housing unit or pendant.

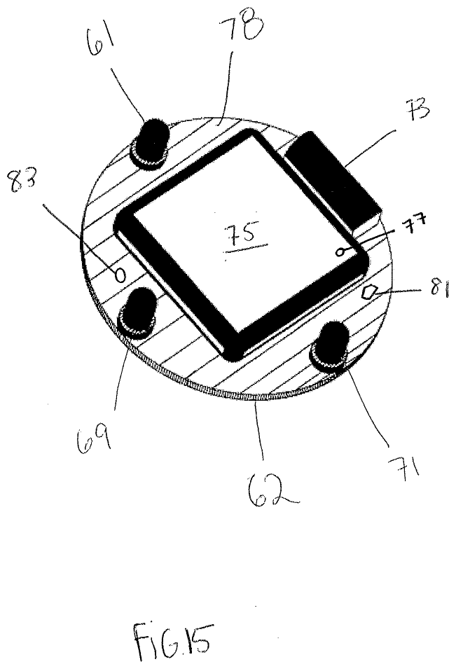

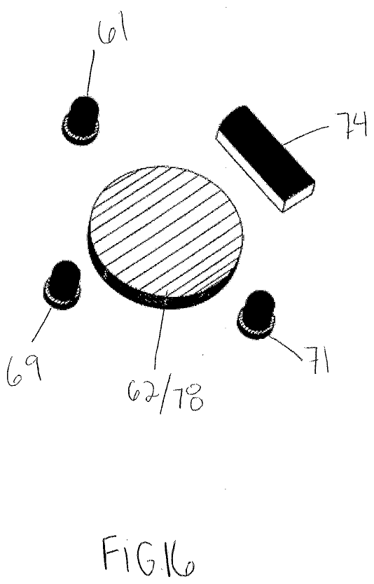

As shown in FIGS. 15-16, the base 62 of the housing unit is a power cell 78 that provides power to the pendant 10. As shown in FIG. 23, the power source is a battery 380 that is secured in a battery compartment 382 that is located in a side 363 of the housing unit 60. The batteries are secured within the housing unit with a battery cover 384 that is screwed into the side of the housing unit. When the battery compartment door is opened as is illustrated in FIG. 23, the battery is exposed for replacement or servicing. However, this is not intended to be limiting as in other embodiments the battery compartment door is secured through a snapping mechanism and/or a tension mechanism.

As shown in FIG. 15, the housing unit includes a receiver 77 for receiving signals which activates the illumination features of the device or a haptics motor 86 of the device, as shown in FIG. 14. Such devices include instructions and circuitry operable to detect location in respect to a transmitted beacon. For example, the device may automatically activate upon nearing a display, feature, attraction or other location within an amusement park which is transmitting a unique beacon which, when received by the device, causes the device to illuminate in a predetermined manner. Other possible automated instructions include emitting colors, playing predefined audio stored in memory of the device or received by the receiver of the device, playing signals which are streamed and received by the integrated receiver, activating the haptics motor 86, and similar functionality.

In one embodiment, housing unit 60, 360 includes a sender (not shown) that transmits a signal to a display, feature, attraction of other location within an amusement park. Accordingly, when a user with the device nears a display, feature, attraction or other location which is capable of receiving a unique beacon being sent from the device, the display, feature, attraction etc. illuminates in a predetermined manner. Other possible automated instructions include emitting colors, playing predefined audio stored in memory of the device or received by the receiver 77 of the device, playing signals which are streamed and received by the integrated receiver, and similar functionality.

For example, as shown in FIG. 15 the pendant 10 may include a proximity detection device 83 which includes a blu-tooth beacon receiver 77. Upon receipt of a unique beacon signal, the device may be programmed by instructions stored in memory chip 73, as shown in FIG. 14, to activate in a particular manner and/or play specific prerecorded or streamed audio signals. Alternatively, the device may incorporate RFID detectors wherein the device, upon recognition of a specific RFID signal, begins emitting a predetermined sequence of signals. Other implementations may be implemented such as GPS location detection and determination.

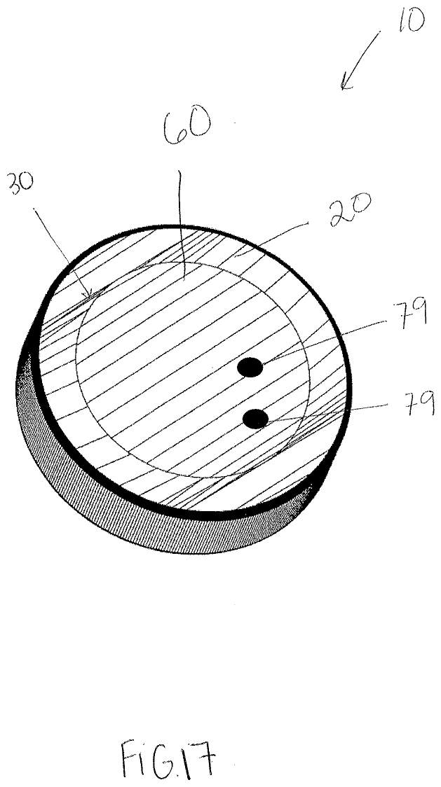

FIG. 17 illustrates the pendant 10 with conductive pins that communicate with other devices. For example, the conductive pins transfer electricity, data and instructions from the pendant to the device into which it plugs. This is one way in which the pendant may be affixed to the wearable band 90. The wearable band may have a corresponding outlet into which the pins plug that may illuminate the wearable band. Moreover, the pendant may be capable of receiving information, data and electricity through these conductive pins from other devices.

Various other features are used in addition to or in place of the various features and aspects described herein. For example, in one embodiment, the illuminated pendant 10, 310 includes a tracking or communication system 81 with a proximity detection device 83. As shown in FIG. 15, the tracking or communication system includes the various capabilities and features disclosed herein for other embodiments, for instance as disclosed for the embodiments shown in FIG. 10. For example, the tracking apparatus 81 or housing unit 60, 360 also includes a speaker, other audio device, a haptics motor 86 and/or a vibrating device. In this embodiment, the control device sends a signal from the communication transmitter/receiver 77 device located in the control device to the communication transmitter/receiver device located in the tracking apparatus, resulting in the emission of a sound, vibration, or light from the LEDs or electroluminescence assembly. The tracking apparatus 81 may, in addition or in place thereof, include various control electronics such as a printed circuit board 74, microcontroller, microprocessor 75, memory chip 73 and associated electronics such as transmitters, receivers 77, as discussed herein for other embodiments.

As shown in FIGS. 22-28, the illuminated pendant 310 is affixed or otherwise attached to a wearable band 390. The wearable band can be any shape or size depending on user specifications and can be worn around any portion of a user's body. The wearable band is secured around a user's arm for instance via a snap-fit mechanism, but this securement shall not be construed as being limiting as it can secured or affixed through any conventional methods.

In another embodiment (not shown), the housing unit 360 is integrated into the wearable band 390 itself and the illuminated pendant 310 is connected to the wearable band. In this embodiment, the illuminated pendant connects to either the housing unit in the wearable band or connects to the wearable band itself. In this embodiment, the pendant is more easily interchangeable depending on the way in which the pendant is connected to the housing unit or wearable band.

Where present, the wearable band may operate independently from or in conjunction with the pendant 10, 310. In some embodiments, the wearable band 390 includes a light string system, with one or more LEDs. In other instances, the wearable band includes an electroluminescence assembly, with an electroluminescent wire, sheet, panel, or tape, and/or an inverter. In some embodiment, the wearable band includes has a power source independent from the power source of the pendant or, in some instances shares a power source with the pendant. This power source includes a battery or other device connected to a printed circuit board. The wearable band is constructed of a pliable or nonpliable material, including but not limited to plastic, thermoplastic, cloth, fabric, wire, rubber, metal, elastic polymer, or other similar material that supports the pendant. The wearable band can also be constructed of any translucent, transparent or other material and may be constructed so as to be flexible or inflexible. In some embodiments, a light string system is constructed within the wearable band and includes an illumination or lamp system electrically connected together with conductive wire or other electrically connective material; each illumination device, lighting or lamp system may further, in some embodiments, include a light assembly and a socket assembly. In various implementations, the light string system and/or the electroluminescence assembly is connected to the LEDs, power source, and associated circuitry used to control the wearable band. The associated circuitry of the wearable band controls the LEDs and/or electroluminescence assembly is also be used to control the light patterns produced by the various illumination devices or lighting units of both the wearable band and the pendant. For example, the light pattern on the wearable band is random, regular, a controlled sequence or pattern, a custom sequence or pattern, and/or sequence or pattern that incorporates constant timing, variable timing, and/or dimming function. In some instances, the pattern or light sequence of LEDs is utilized in addition or in place of the electroluminescence assembly and are utilized to provide illumination which is coordinated with the pattern or light sequences of the pendant.

In the embodiment shown in FIG. 18, the pendant 10 is capable of being magnetically secured to a user's clothing. In this embodiment, the pendant includes a first magnet (not shown) secured thereto, preferably to a back surface 32 of the pendant. This magnet can be secured by any methods, for instance via glue. This magnet is attracted to a second magnet 82 that a user slides behind a shirt or article of clothing. This provides an illusion that the pendant is floating.

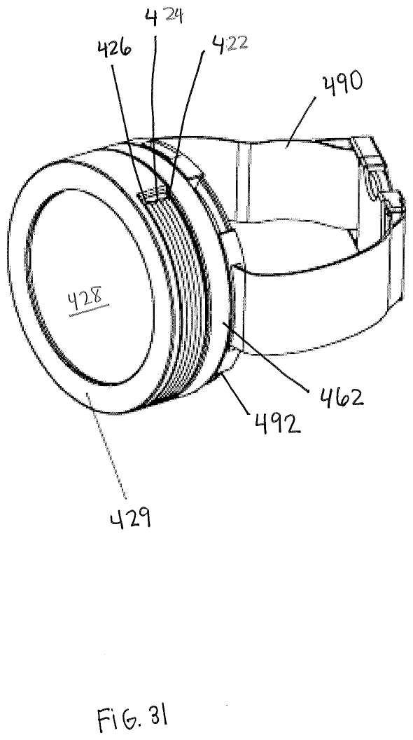

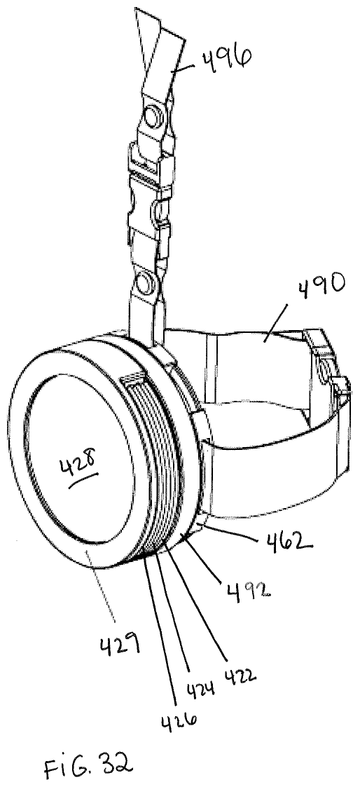

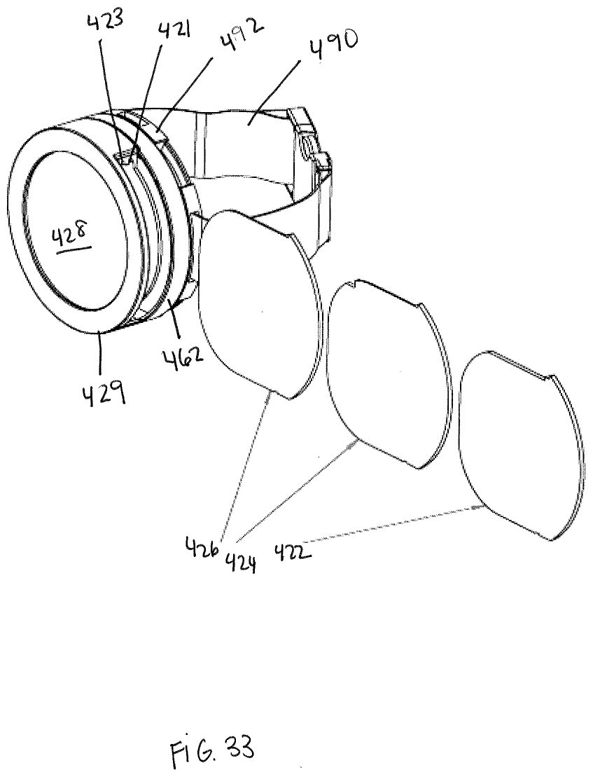

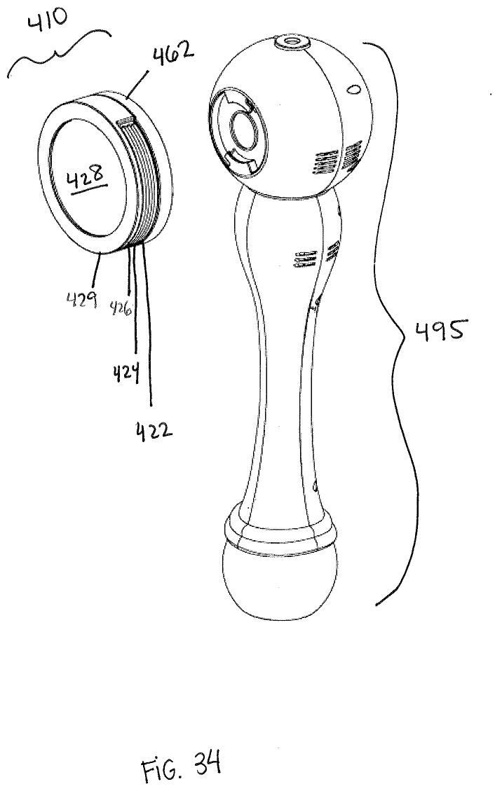

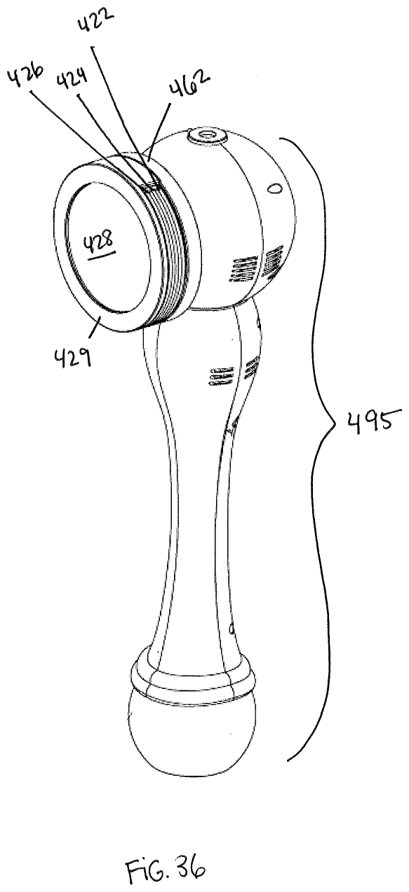

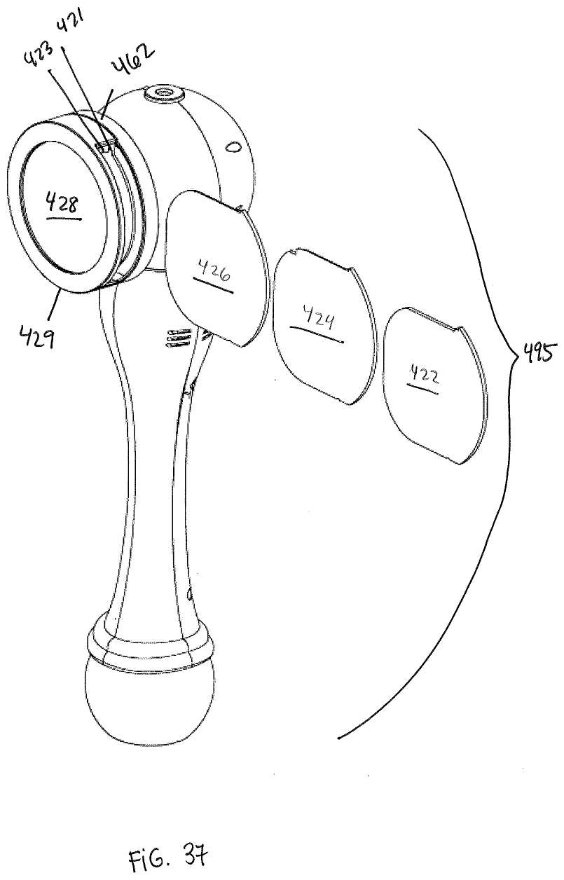

FIGS. 29-37 show another embodiment of an illuminating pendant 410, which can be affixed to a wristband 490, as shown specifically in FIGS. 29-33 or a bubble producing toy 495 as shown in FIGS. 34-37. For example, the bubble producing toy is a light up bubble wand, which is made by Applicant and is disclosed in U.S. patent application Ser. No. 17/335,447, which application is incorporated by reference herein in its entirety. The inner components and structure of the illuminating pendant shown in FIGS. 29-37 are the same regardless of the device to which it is affixed, i.e., a wristband or a handheld bubble producing toy. Furthermore, the securing mechanism by which it affixes to the wristband and the bubble producing toy is the same.

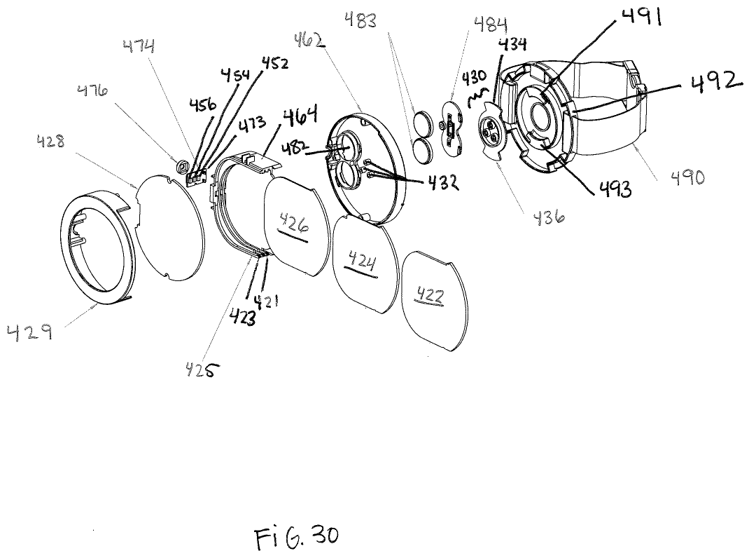

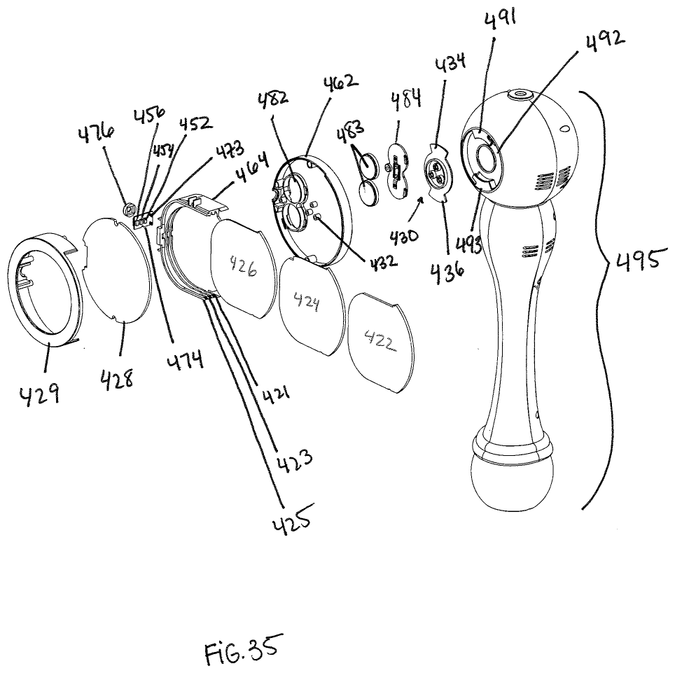

As shown specifically in FIGS. 30 and 35, the illuminating pendant 410 includes a housing unit 460, which includes a base 462 and a cover 464. The base includes a battery compartment 482, which houses batteries 483 that are secured therein via a battery compartment door 484. The batteries are electrically connected to the inner electrical components of the device. Secured to a back side of the base is a latch 430, which is secured thereto via screws 432. This latch includes fins, 434, 436, which align with notches 491, 493 located within a base structure 492 that is secured within the wristband 490 and bubble producing toy 495. To secure the illuminated pendant to the wristband or bubble producing toy, a user inserts the latch into the base and twists the fins into the notches 491, 493 which secure the pendant within the wristband or bubble producing toy. By twist the fins into the notches, the illuminating pendant locks into place within the base of the wristband or bubble producing toy. The illuminating pendant is therefore easily removeable and replaceable.

Secured within the housing unit 460 are various types of control circuitry or other inner components. See discussion for FIGS. 6-10 for various inner components of the housing unit, which should be interpreted as applying to all embodiments discussed herein. For example, the housing unit may include control circuitry such as proximity detection devices 473 such as a tracking apparatus, or various other control electronics such as a printed circuit board 474, microcontroller, microprocessor, memory chip and associated electronics such as transmitters, receivers.

As shown in FIGS. 30 and 35, the cover 464 of the housing 460 secures to the base via screws. The cover includes slots 421, 423, 425 into which corresponding layers of translucent material 422, 424, 426 slip fit into. As discussed herein for other embodiments of the illuminating pendant, each layer may be constructed of a translucent or transparent material capable of transmitting and/or radiating light. For example, in some embodiments, the translucent material may include but not be limited to, glass, plexiglass, acrylic, resin, and/or a combination thereof. Each layer of the pendant may also have a light reflective image which is contained in and/or on the translucent material. In some embodiments, the image may be etched, sandblasted, molded, engraved, imprinted, ingrained, cut, impressed and/or outlined into or on the translucent material forming a light radiating portion. Further, such images may be produced by embedding other reflective, refractive or other material within the layer.

Secured to an edge of the cover 464 is a printed circuit board 474, with LEDs 452, 454, 456 connected thereto. For example, as shown in FIGS. 30, 33, 35 and 37 there are three layers of translucent material so there are three LEDs, i.e., one LED for each layer of translucent material. Each LED aligns with an edge of the respective layer of translucent material to which it is secured. Further electrically connected to the printed circuit board is a switch 476. As with other embodiments discussed herein, the switch or other circuit for activating or deactivating the device may be mechanical, such as a toggle switch, depression switch, three-position switch and other similar mechanical activation assemblies. The switch activates the electrical components of the device and illuminates the LEDs in patterns associated with the switch. Accordingly, for example, when a user presses the switch or approaches a display using proximity detection devices, it illuminates the LEDs in a pattern associated with a first predefined sequence. This illuminates the LEDs in each layer to appear as a moving animation, for example if light reflective images are etched into each layer.

As shown in FIGS. 29-37, the illuminating pendant 410, further includes a lens 428, which is secured adjacent to the outer most layer of translucent material via an enclosure 429. This enclosure can be screwed to the cover 464 or, as shown in FIGS. 30 and 35, the cover includes notches into which the enclosure latches. This lens is constructed of a translucent or transparent material capable of transmitting and/or radiating light. Further, it may have a mirrored appearance that aids in reflecting the moving animation from the LEDs.

FIG. 38 shows an illuminating lantern 510, which utilizes technologies as discussed herein for the various embodiments of the illuminating pendant and housing unit. The illuminating lantern includes a lantern body 530, which includes four sides 534, 535, 536, 537, wherein each side includes various layers of translucent material, a housing unit 560, which is secured atop the lantern body and a base 562, which is secured below the lantern body.

The housing unit 560 includes a base 561 and a cover 564. The base includes a battery compartment 582, which houses batteries (not shown) that are secured therein via a battery compartment door (not shown). The batteries are electrically connected to the inner electrical components of the device.

Secured within the housing unit 560 are various types of control circuitry, such as those which are discussed herein for other embodiments, such as for FIGS. 6-10. For example, the housing unit may include control circuitry such as proximity detection devices 573 such as a tracking apparatus, or various other control electronics such as a printed circuit board 574, microcontroller, microprocessor, memory chip and associated electronics such as transmitters, receivers.

As shown in in FIG. 38, the housing unit is secured atop the lantern body 530. The lantern body includes four sides 534, 535, 536, 537, but this should not be construed as limiting as the lantern can include any number of sides. Secured within the lantern body on each side are multiple layers of translucent material. Only one side of translucent material will be discussed but the discussion should be interpreted as applying to all sides shown in FIG. 38. In this embodiment, each side includes three layers of translucent material 522, 524, 526, which are collinearly connected. There can be any number of layers of translucent material. As discussed herein for other embodiments of the illuminating pendant, each layer may be constructed of a translucent or transparent material capable of transmitting and/or radiating light. For example, in some embodiments, the translucent material may include but not be limited to, glass, plexiglass, acrylic, resin, and/or a combination thereof. Each layer of the pendant may also have a light reflective image which is contained in and/or on the translucent material. In some embodiments, the image may be etched, sandblasted, molded, engraved, imprinted, ingrained, cut, impressed and/or outlined into or on the translucent material forming a light radiating portion. Further, such images may be produced by embedding other reflective, refractive or other material within the layer. Each layer of translucent material includes a notch 525, 527, 529 into which an LED 552, 554, 556 secures. This aids in the LEDs illuminating only the layer into which it is secured.

Secured to a bottom edge each LED 552, 554, 556 is a printed circuit board 575. As there are four sides with three layers of translucent material on each side, there are four printed circuit boards, each of which includes three LEDs, which are aligned with the respective layers of translucent material. As with other embodiments discussed herein, this lantern may have a switch or other circuitry for activating or deactivating the device may be mechanical, such as a toggle switch, depression switch, three-position switch and other similar mechanical activation assemblies. The switch activates the electrical components of the device and illuminates the LEDs in patterns associated with the switch. Accordingly, for example, when a user presses the switch or approaches a display using proximity detection devices, it illuminates the LEDs in a pattern associated with a first predefined sequence. This illuminates the LEDs in each layer to appear as a moving animation, for example if light reflective images are etched into each layer.

The printed circuit boards are secured to a top portion 561 of the base 562, for instance via glue. Secured within the base is a projector 565 that projects images out the bottom surface 536 of the base unit.

It is to be understood that although illustrated in the form of a wearable band 390 and magnetized accessory, the illuminated pendant shown in the various embodiments herein is not so limited, as the illuminated pendant may be worn by a user (as a necklace, helmet, glasses, bracelet, etc.), attached to other objects, held in a user's hand, used as part of a display, and the like. Furthermore, the illuminated pendant may be formed in any shape, including the shape of eyeglasses, a toy star, toy planet, crystal, sphere, rod, staff, blade, disk, device, wand, multi-sided, polyhedron shape, geometric shape, triangle shape, quadrilateral shape, pentagon shape, hexagon shaped, septagon shaped, octagon shaped, polygon of any number of sides, a commonly recognizable toy(s), or consumer product. In some instances, the illuminated accessory may be in the form of a character, caricature, celebrity or person's shape or image (in whole or part), a logo, symbol, or other recognizable items (e.g. a rocket, airplane, car, animal, bug, plant, rock, rock formation, body part(s), machine, vehicle, boat, alien, wand, sword, knife, gun, pistol, boat, submarine, toy sword, toy vehicle, toy gun, toy shield, toy wand, doll, figurine, action figure, remote controlled vehicle, remote controlled airplane, other remote control toy, hand held toy(s), construction toy(s), toy block(s), accessories, apparel, footwear, hair accessories, jewelry, sports balls or equipment, bike accessories, bike spokes, costumes, headwear, skateboard accessories, wheels, wheel accessories, vehicle accessories, skateboard wheels, snowboard, yo-yo, spinning top, fan, frisbee, nightlight, electronic device, radio, clock radio, mobile phone accessory, and/or desktop device).

While several embodiments of the present invention have been shown and described, it is understood that many changes and modifications can be made thereto without departing from the scope of the inventions as disclosed herein.

1. An illuminating pendant affixed to a bubble producing toy, wherein the illuminating pendant comprises:
a housing unit;
one or more layers of translucent material connected to the housing unit, wherein the one or more layers are collinearly connected;
one or more LEDs connected to an edge of each of the one or more layers of translucent material; and
control circuitry secured within the housing unit and is electrically connected to the one or more LEDs and to a power source;
wherein the control circuitry comprises a receiver and a proximity detection device;
wherein the control circuitry detects a first signal location proximate to a first proximity beacon and illuminates the one or more LEDs in a pattern associated with the first signal location.

2. The illuminating pendant of claim 1, wherein the control circuitry further comprises an internal controller connected to the power source, wherein the internal controller is communicatively activated by a remote device.

3. The illuminating pendant of claim 1, wherein the control circuitry further detects a second signal location proximate to a second proximity beacon and illuminates the one or more LEDs in a second predefined sequence associated with the second signal location, wherein the second predefined sequence is different from the first predefined sequence.

4. The illuminating pendant of claim 1, wherein the control circuitry controls a function of the one or more LEDs selected from the group consisting of intensity, color temperature, color illumination and timing.

5. The illuminating pendant of claim 1, wherein the one or more layers includes light reflective images etched therein.

6. An illuminating lantern comprising:
a housing unit;
a base;
at least three sides connected between the housing unit and the base, wherein each of the sides comprises one or more layers of translucent material, wherein each of the one or more layers are collinearly connected;
one or more LEDs connected to an edge of each of the one or more layers of translucent material; and
control circuitry, which is secured within the housing unit and is electrically connected to the LEDs and a power source;
wherein the control circuitry comprises a receiver and a proximity detection device;
wherein the control circuitry detects a first signal location proximate to a first proximity beacon and illuminates the one or more LEDs in a first predefined sequence associated with the first signal location.

7. The lantern of claim 6, wherein the control circuitry further comprises an internal controller connected to the power source, wherein the internal controller is communicatively activated by a remote device.

8. The lantern of claim 6, wherein the control circuitry further detects a second signal location proximate to a second proximity beacon and illuminates the one or more LEDs in a second predefined sequence associated with the second signal location, wherein the second predefined sequence is different from the first predefined sequence.

9. The lantern of claim 6, wherein the control circuitry controls a function of the one or more LEDs selected from the group consisting of intensity, color temperature, color illumination and timing.

10. The lantern of claim 6, wherein the base further comprises a projector, which projects images outside of the base.

11. The lantern of claim 6, wherein the at least three sides are surrounded by an enclosure, which secures to the base and the housing unit.

12. The lantern of claim 11, wherein the enclosure is made of a reflective material.

13. The lantern of claim 6, wherein the housing unit further comprises a handle and is capable of being worn.

14. An illuminating lantern comprising:
a housing unit;
a base;
four sides connected between the housing unit and the base, wherein each side comprises one or more layers of translucent material, wherein the one or more layers are collinearly connected and each of the one or more layers includes light reflective images etched therein;
one or more LEDs connected to an edge of each of the one or more layers of translucent material; and
control circuitry secured within the housing unit and electrically connected to the LEDs and to a power source;
wherein the control circuitry comprises a receiver and a proximity detection device; and
wherein the control circuitry detects a first signal location proximate to a first proximity beacon and illuminates the one or more LEDs in a first predefined sequence associated with the first signal location.

15. The lantern of claim 14, wherein the control circuitry further detects a second signal location proximate to a second proximity beacon and illuminates the one or more LEDs in a second predefined sequence associated with the second signal location, wherein the second predefined sequence is different from the first predefined sequence.

16. The lantern of claim 14, wherein the base further comprises a projector, which projects images outside of the base.

17. The lantern of claim 14, wherein the control circuitry further comprises an internal controller connected to the power source, wherein the internal controller is communicatively activated by a remote device.

18. The lantern of claim 14, wherein the control circuitry controls a function of the one or more LEDs selected from the group consisting of intensity, color temperature, color illumination and timing

19. The lantern of claim 14, wherein the sides are surrounded by an enclosure, which secures to the base and the housing unit.

20. The lantern of claim 19, wherein the enclosure is made of a reflective material.
